(19) United States
(12) Patent Application Publication
(10) Pub. No.: US 2004/0060456 A1
(43) Pub. Date: Apr. 1, 2004

(54) Multi-level batch fryer for alternative wok cooking

(76) Inventor: Jing-Yau Chung, Houston, TX (US)

Correspondence Address: MARK A OATHOUT, 3730 KIRBY DRIVE, SUITE 830, HOUSTON, TX, 77098

(21) Appl. No.: 10/672,738

(22) Filed: Sep. 26, 2003

Related U.S. Application Data
(60) Provisional application No. 60/413,921, filed on Sep. 26, 2002.

(51) Int. Cl. A47J 37/12; A23L 1/00

(52) U.S. Cl. 99/407; 99/403; 426/438

(57) ABSTRACT

A multi-level batch fryer includes a vat containing hot oil, a drive mechanism, a timer and a multi-level food compartment. The multi-level food compartment contains food to be fried in the vat containing hot oil. The drive mechanism moves the compartment to different levels either submerged in the hot oil, out of the hot oil or partially within the hot oil. Such movement is dependant on the setting of the timer.

### CROSS-REFERENCE TO RELATED APPLICATIONS

This application claims the benefit of U.S. provisional application No. 60/413,921 filed Sep. 26, 2002.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Description of the Related Art

Most authentic restaurant quality Chinese entrees are prepared with a flaming wok with hot oil. During the food preparation, typically, it takes about ten to fifteen minutes to cut the food components into small pieces and it takes another five minutes or so to cook the cut components by flipping them over and over above a hot wok with oil at 450 degrees Fahrenheit or higher. The chef who prepares the dishes in a typically hot and uncomfortable kitchen environment is generally well trained in cutting and putting together the complex food ingredients. This includes preparing different food components requiring different preparation times. For example, when preparing beef and broccoli, the beef must be cooked longer than the broccoli and both components should not be overcooked. The chef is also trained to monitor the wok temperature and to handle the flipping motion or up and down motion mentioned above.

### BRIEF SUMMARY OF THE INVENTION

The present invention is related to new cooking equipment and techniques for preparing large or small quantities of the same restaurant quality Chinese foods but with improved efficiency, less or no requirement for cooking skill, with control over the amount of grease in the finished entree.

The present invention includes a cooking device having multiple level food compartments attached to a mechanism moving in and out of hot oil or hot water for heating foods contained in the food compartments. The mechanism provides not only the in and out motion mentioned above but also a slow rotating motion or up and down motion for agitating the foods for faster and more uniform heating. It also provides a fast rotating motion to eliminate residual oil or water by means of centrifugal force. The multiple levels of compartments provides different heating duration for different level compartments by controlling the in and out time for each compartment.

In another embodiment, the multi-level batch fryer includes a vat containing hot oil, a drive mechanism, a timer and a multi-level food compartment. The multi-level food compartment contains food to be fried in the vat containing hot oil. The drive mechanism moves the compartment to different levels either submerged in the hot oil, out of the hot oil or partially within the hot oil. Such movement is dependant on the setting of the timer.

Certain embodiments of this invention are not limited to any particular individual features disclosed, but include combinations of features distinguished from the prior art in their structures and functions. Features of the invention have been broadly described so that the detailed descriptions that follow may be better understood, and in order that the contributions of this invention to the arts may be better appreciated. There are, of course, additional aspects of the invention described below. These may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes, addresses and meets the previously-mentioned preferences or objectives in its various possible embodiments and equivalents thereof. To one of skill in this art who has the benefit of this invention's realizations, teachings, disclosures, and suggestions, other purposes and advantages will be appreciated from the following description and the accompanying drawings. The detail in the description is not intended to thwart this patent's object to claim this invention no matter how others may later disguise it by variations in form or additions of further improvements. These descriptions illustrate certain preferred embodiments and are not to be used to improperly limit the scope of the invention which may have other equally effective or legally equivalent embodiments.

### BRIEF DESCRIPTION OF THE SEVERAL VIEWS OF THE DRAWINGS

FIG. 1 is a perspective view of one embodiment of the invention.

FIG. 2 is an elevational view in partial-section of one embodiment of the invention showing a submerged food compartment.

FIG. 3 is a view similar to FIG. 2 showing a partially submerged food compartment.

FIG. 4 is a view similar to FIG. 2 showing an un-submerged food compartment.

FIG. 5 is an elevational view (with part of the view in break-away) of another embodiment of the invention showing an un-submerged food compartment.

FIG. 6 is a top view of the embodiment shown in FIG. 5.

FIG. 7 is an elevational view of the food compartment with the cover being opened from the embodiment shown in FIG. 5.

### DETAILED DESCRIPTION OF THE INVENTION

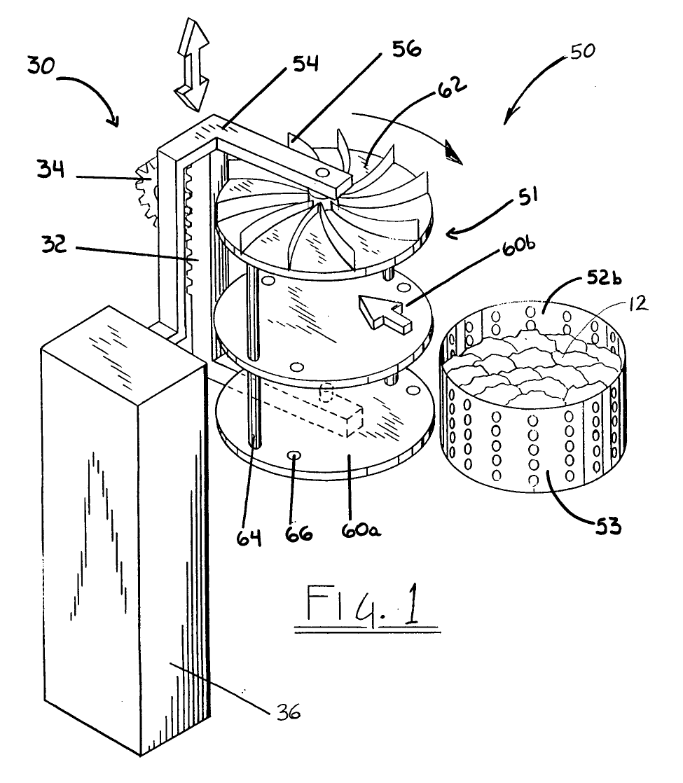

Referring to FIGS. 1-4, the present invention in one embodiment comprises a multi-level batch fryer 10 having a compartment or vat 20 filled with a bath of hot oil 22 or some other suitable heating medium such as hot water; a food compartment 50 having independent containers 52; a manual or automated drive mechanism 30; and equipment such as an air motor 55 and fins 56 for rotating the compartment 50 to spin-out the hot oil.

The vat 20 is filled with a bath of hot oil 22 for submerging and frying various components 12 of a food product. A circulation line 24 is connected to and from the vat 20. The circulation line 24 contains a filter 25, a pump 26 and a heater 27 for processing the hot oil 22. Alternatively, a compartment (not shown) having separate sections and injection lines for injecting hot oil into the sections for frying a food component 12 could be used in place of the vat or compartment 20.

The various food components 12 of an entree are placed in the independent containers 52a and 52b. The independent containers 52a, b must be separated according to time required to fry a food component 12 respectively placed in each individual container 52a, b. This may be accomplished by having multiple levels (two shown) of containers 52a and 52b. Other arrangements are possible. The containers 52a and 52b may comprise circular baskets 52a and 52b although other shapes may be used. If the food to be prepared includes three food components, each requiring a different cooking time, then the multi level batch fryer 10 can be made with three separate levels having three separate baskets 52. The baskets 52a and 52b must allow hot oil to flow through the baskets 52a and 52b. Accordingly, the baskets 52a and 52b may include a perforated or mesh base (not shown) and a perforated or mesh sidewall 53 (details shown in FIG. 1 only). The base of the baskets 52a and 52b may include prongs (not shown) to hold the baskets 52a and 52b in the stand 51, as described below.

The stand 51 defines the multiple levels upon which the baskets 52a and 52b will be mounted. The stand 51 includes base 60a, base 60b, a top 62 and connecting rods 64 for interconnecting the bases 60a and 60b and the top 62. The bases 60a and 60b may contain detents 66 for receiving the prongs located on the bottom of the baskets 52a and 52b for holding the respective baskets 52a and 52b on the respective bases 60a and 60b of stand 51. The stand 51 is mounted on and rotatable with respect to a bracket 54.

A manual or automated drive mechanism 30 moves the stand 51 for movement of the baskets 52a and 52b in and out of the bath of hot oil 22 contained in the vat 20. One type of drive mechanism 30 which could be used includes a rack 32 and pinion 34, and a bracket guide 36. The rack 32 is constructed on one side of a bracket 54. The pinion 34 may be driven by a motor (not shown). The motor may comprise a programmable step motor. The step motor is programmed to set the speed at which the stand 51 will ascend or descend, an up and down motion of the stand 51 as further described below, the stop positions for the stand 51 and the amount of time (cooking time) for the stand 51 at each stop position.

There are several options for driving the stand 51 including the baskets 52a and 52b. For example, both baskets 52a and 52b may be driven down until both are submerged in the bath of hot oil 22. Then baskets 52a and 52b are quickly driven with an alternating up and down motion to agitate or shake the contents of the baskets 52a and 52b in the bath of hot oil 22. This enhances the heat transfer to the food components and the uniform preparation of the food product in the bath of hot oil 22. After the food component contained in the top basket 52b has been properly prepared (e.g. about ten to fifteen seconds for broccoli), the stand 51 is driven upward until the top basket 52b emerges from the bath of hot oil 22. Next, the lower basket 52a is agitated for the purposes and as discussed above. The lower basket 52a is then driven out of the bath of hot oil 22 after the food component in the lower basket 52a has been adequately prepared (e.g. about an additional thirty seconds for beef). The up and down motion for the purpose of agitating the food product could be replaced by some other agitating action such as a spinning motion to enhance heat transfer and distribute the food product.

In another example, the lower basket 52a can first be driven into the bath of hot oil 22 followed by submerging both baskets 52a and 52b in the bath of hot oil 22 prior to raising both baskets 52a and 52b out of the bath of hot oil 22.

Other types of drive mechanisms 30 may be utilized. In another example, the stand 51 is manually or automatically pushed into the bath of hot oil 22 until baskets 52a and 52b are submerged. The drive mechanism 30 includes a buoyant support (not shown) fixed to the bracket 54. The buoyant support pops the stand 51 up to a second stop position where only the lower basket 52a will be submerged. After a sufficient cooking time has elapsed, then the buoyant support pops the entire stand 51 out of the bath of hot oil 22. Any suitable manner may be used to predetermine and set the cooking time at each position. For example, a solenoid stop (not shown) set by a timer (not shown) could be used.

As discussed above, in one embodiment for agitating the food components to enhance heat transfer it is useful to rotate the baskets 52a and 52b in the bath of hot oil 22. Once the stand 51 has completely moved out of the bath of hot oil 22, it is also useful to drain the hot oil from the baskets 52a and 52b. Both of these functions can be accomplished by spinning or rotating the stand 51. In one embodiment, the stand 51 may be rotated by air. Fins 56 are connected to top 62 of the stand 51. An air motor 55 may be connected to the top of a shell 57 (FIG. 2). Once the stand 51 ascends into the shell 57, the air motor 55 is started to drive the fins 56 for spinning the stand 51. The hot oil is centrifugally driven out of the baskets 52a and 52b, drains from the baskets 52a and 52b and drains from the inside of the shell 57 under the influence of gravity.

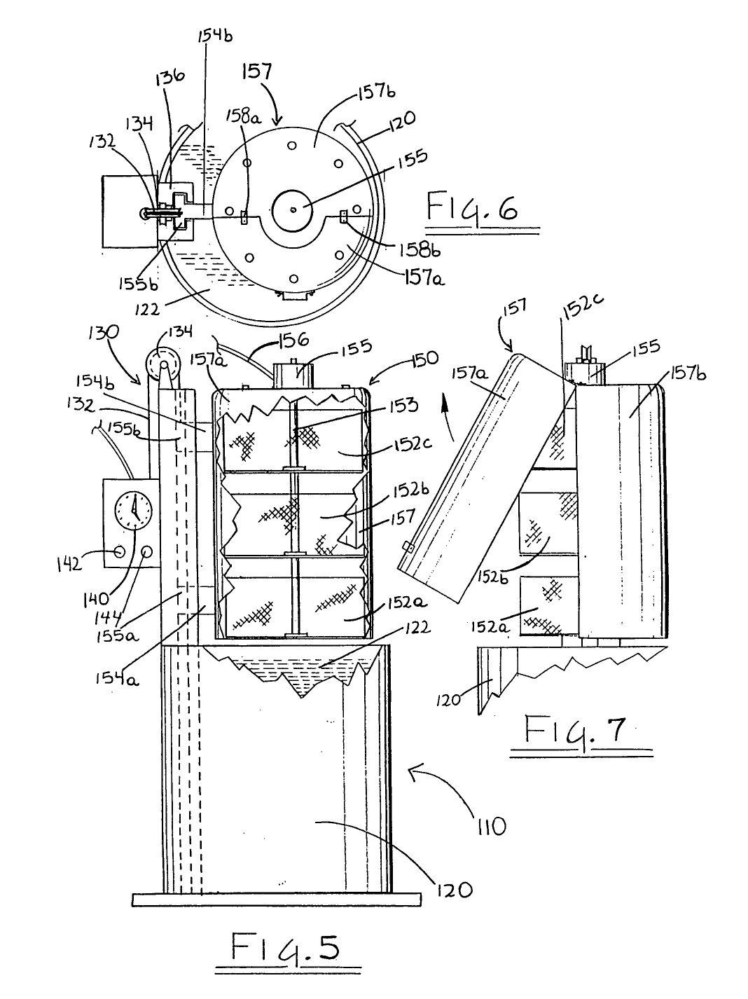

The air motor 55 and the shell 57 may also be designed to move up and down with the stand 51. A motor (see FIGS. 5-7) could also be mounted on top of the bracket 54 and coupled to the stand 51 by a drive shaft. If the shell 57 is stationary, then the motor should include a telescoping drive shaft (not shown) or a drive shaft made from a flexible cable (not shown) with one end fixed to the motor and the other end coupled to the stand 51.

The stand 51 is journaled to the bracket 54. The shell 57 is a simple enclosure to catch oil which spins out of the baskets 52a and 52b. The shell 57 may include a cover or door 57a which is opened to insert and remove baskets 52a and 52b. The shell 57 could be opened by any other suitable means.

The present invention in another embodiment 110 can be seen by referring to FIGS. 5-8. A typical vat 120 contains a bath of hot oil 122 for frying a food product (not shown). The vat 120 includes a heater (not shown) and a filter system (not shown) for treating the bath of the bath of hot oil 122.

The drive mechanism 130 includes a cable 132 which runs over a pulley 134 and attaches to supports 154a and 154b extending from the multi-level compartment 150. Pulley 134 may be connected to a chain (not shown) driven by a sprocket (not shown) attached to a motor (not shown). The drive mechanism 130 also includes a rail 136. Rail 136 has a groove which runs vertically. The ends 155a and b of the arms 154a and 154b are adapted to fit into the groove. The rail 136 functions as a guide for the arms 154a, b as the arms 154a, b are driven up or down by the cable 132. The rail 136 also functions as a support for the compartment 150.

Compartment 150 includes frying baskets 152a, 152b, 152c. Each of the baskets 152a-c may include a cover (not shown) to prevent food from floating out of the baskets 152a-c when the baskets are submerged in the bath of hot oil 122. Each of the baskets 152a-c is mounted on a drive shaft 153. The drive shaft 153 is coupled to a motor 155. A power cord 156 attached to the motor 155 has slack allowing the motor 155 to move up and down with the compartment 150. The compartment 150 includes an outer shell 157 which is connected to the arms 154a and b and to the motor 155. Grease may drain out of the bottom of the cover 157 which is open. The cover 157 may include two half shells 157a and 157b connected by a door mechanism 158 having hinges 158a and 158b. Half shell 157a may be rotated upward for accessing the baskets 152a-c.

Controls for the multi-level batch fryer 10 include timer 140, start button 142 and stop button 144.

In an alternative embodiment similar to FIGS. 5-7, the arms 154 may be driven up and down by a spring mechanism (not shown) where a release may be controlled by timer 140. The compartment 150 may include a rotating plate (not shown) at the bottom of the compartment 150. Frying baskets 152a and 152b are placed on this rotating plate. The rotating plate is driven in any suitable manner known to one of ordinary skilled in the art. The baskets 152a and 152b may be accessed through a door (not shown) in the cover 157.

The multi-level batch fryer 10 of FIGS. 1-4 is operated as follows in one continuous process:

The multi-level fryer 10 starts at the stop position shown in FIG. 4. Shell door 57a is rotated upward for accessing the baskets 52a, b. Separate food components (in this case two), requiring different frying times, are inserted into different baskets 52a, 52b. For example, if the operator is preparing beef broccoli, he/she places the beef requiring a longer frying time in the lower basket 52a and the broccoli (as well as any other desirable vegetable) in the basket 52b. The shell door 57a is rotated down to close the shell or cover 57.

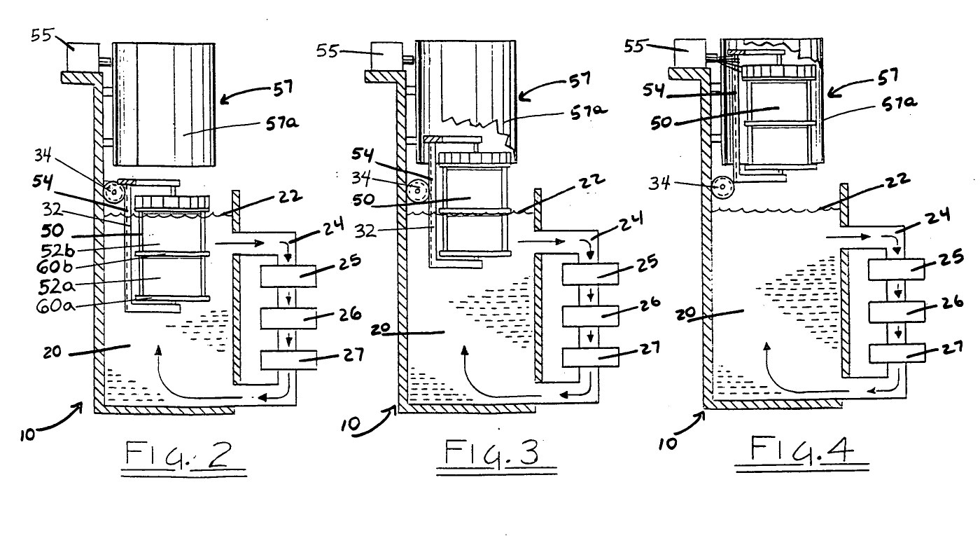

Once the frying process is initiated, the timer in conjunction with other controls and equipment (not shown) known to one of ordinary skill in the art will drive the pinion 34. The compartment 50 descends/drops until the lower basket 52a is submerged in the bath of hot oil 22. This position is shown in FIG. 3. At this level the controls will stop driving pinion 34. This stops the descent of compartment 50. The timer in conjunction with the other controls keep track of the amount of time required to fry the beef which is in addition to the time required to fry the broccoli. Once the time has expired, the pinion 34 is driven again causing the compartment 50 to further descend/drop until basket 52b is submerged in the bath of hot oil 22. This position is shown in FIG. 2. The baskets 52a and 52b will remain at this position for the mount of frying time set by the timer (referring to FIGS. 5-7, when preparing an entree such as beef and broccoli, there will not be a third food component requiring a third, different frying time and, therefore, there is no need for compartment 150 to further descend into the bath of hot oil 122 to submerge basket 152c (or there is no need to include basket 152c)). The compartment 50 may be agitated, as discussed above, for redistribution of the beef and broccoli while frying. Once the frying time at the second position has expired, the motor reverses to rotate pinion 34 counter-clockwise. This drives compartment 50 out of the bath of hot oil 22. Air motor 55 initiates when all of the baskets 52a, b are out of the bath of hot oil 22. Excess oil is removed by centrifugal force and gravity. Oil drains from the baskets 52a, b and from the outer shell 57 into the vat 20 during the spin-out procedure. The operator lifts the shell door 57a and removes the fried beef and broccoli. The beef and broccoli are mixed with a prepared sauce for serving to a customer.

The frying time for meat in oil at three hundred and seventy degrees fahrenheit or higher is approximately thirty seconds depending on the thickness of the meat. The frying time for vegetables in the same oil is approximately ten seconds or less. However, since the meat and the vegetables are fried simultaneously, the total frying time is dependent on the time to fry the meat, i.e. thirty seconds. Therefore, it is believed, the entire process as described above for beef and broccoli, including spinning out the oil, can be completed in about forty-five seconds.

The procedure described above can be altered as follows. When frying beef and broccoli, the baskets 52a and 52b can first be submerged together in the bath of hot oil 22 (FIG. 2). Then, after the time for frying the broccoli has expired, the compartment 50 can be raised or popped up to a position where only basket 52a is submerged. Basket 52a will be raised or popped up once the frying time for beef has expired. Then, baskets 52a and 52b are rotated to spin out excess oil.

Any known agitating or spinning mechanism can be used in the invention. A hydraulic or pneumatic system (not shown) may be used to drive the compartment 50 up or down.

In conclusion, therefore, it is seen that the present invention and the embodiments disclosed herein and those covered by the claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any claims is to be understood as referring to all equivalent elements or steps. The claims are intended to cover the invention as broadly as legally possible in whatever form it may be utilized.

What is claimed is:

1. A multilevel batch fryer for fast, consistent Chinese cooking, comprising:
a vat containing a volume of hot oil;
a drive mechanism including a guide bracket connected to one side of the vat wherein the guide bracket runs perpendicular to a plane of a surface of the volume of hot oil;
a food compartment connected to the drive mechanism and supported by the guide bracket;
a plurality of food containers mounted in the food compartment each positioned at a different level within the food compartment; and
a motor connected to the food compartment.

2. The apparatus according to claim 1, further including a circulation line connected to the vat.

3. The apparatus according to claim 2, further including a filter connected to the circulation line.

4. The apparatus according to claim 2, further including a pump connected to the circulation line.

5. The apparatus according to claim 2, further including a heater connected to the circulation line.

6. The apparatus according to claim 2, further including a filter, a pump and a heater connected to the circulation line.

7. The apparatus according to claim 1 wherein the plurality of food containers comprise a plurality of food baskets.

8. The apparatus according to claim 1, further including a drive shaft attached to the motor at one end and attached to the food compartment at the other end.

9. A method for fast, consistent Chinese cooking, comprising the steps of:
Starting a food compartment at a position outside of a vat of hot oil;
Accessing a plurality of food containers and inserting food product into different food containers;
closing the plurality of food containers at different levels in the food compartment; descending the food compartment into the vat of hot oil until at least a lower basket is submerged in the hot oil;
raising the food compartment out of the hot oil once a frying time has expired; and
moving the food compartment to remove the oil.

10. The method according to claim 9, wherein said step of moving the food compartment comprises spinning the food compartment.

11. The method according to claim 9, further including moving the food compartment while submerged in the hot oil.

12. The method according to claim 11, wherein said step of moving the food compartment while submerged in the hot oil comprises agitating the food compartment.

13. The method according to claim 9, further including:
further descending the food compartment into the vat of hot oil until at least a second basket is submerged in the hot oil.

14. The method according to claim 13, further including:
further descending the food compartment into the vat of hot oil until at least a third basket is submerged in the hot oil.

15. The method according to claim 9, wherein said raising step comprising raising at least one food compartment out of the hot oil while at least one other food compartment remains submerged in the hot oil; maintaining this position for a second frying time; and then raising the other food compartment out of the hot oil.
